(19) United States
(12) Patent Application Publication
(10) Pub. No.: US 2011/0292858 A1
(43) Pub. Date: Dec. 1, 2011

(54) BROADCASTING COMMUNICATION IN A WIRELESS COMMUNICATION SYSTEM

(76) Inventors: Alan Edward Jones, Calne (GB); Nicholas William Anderson, Avon (GB)

(21) Appl. No.: 13/125,441

(22) PCT Filed: Oct. 23, 2009
(86) PCT No.: PCT/EP09/64019

§ 371 Date: Aug. 22, 2011

(30) Foreign Application Priority Data
Oct. 24, 2008 (GB) 0819194.1

(51) Int. Cl. H04W 4/06

(52) U.S. Cl. 370/312; 370/328

(57) ABSTRACT

A method for supporting broadcast transmissions and unicast communications in a wireless communication system is described. The method comprises supporting unicast communication in a first mode of operation wherein at least one unicast data transmission unit is encoded and communicated within a time-continuous sub-frame of a first length and a first number of timeslots. The method further comprises supporting broadcast transmission in a second mode of operation, wherein at least one broadcast data transmission unit is encoded communicated over a time period that comprises a discontinuous plurality of the time-continuous sub-frames of the first length.

### FIELD OF THE INVENTION

The invention relates to utilisation of communication resources in cellular communication systems and in particular, but not exclusively, to supporting broadcast communication in a time-division duplex 3^{rd} Generation Partnership Project (3GPP) cellular communication system.

### BACKGROUND OF THE INVENTION

Currently, 3rd generation cellular communication systems are being rolled out to further enhance the communication services provided to mobile phone users. The most widely adopted 3rd generation communication systems are based on Code Division Multiple Access (CDMA) and Frequency Division Duplex (FDD) or Time Division Duplex (TDD) technology. In CDMA systems, user separation is obtained by allocating different spreading and/or scrambling codes to different users on the same carrier frequency and in the same time intervals. This is in contrast to time division multiple access (TDMA) systems, where user separation is achieved by assigning different time slots to different users.

In TDD systems, the same carrier frequency is used for both uplink transmissions, i.e. transmissions from the mobile wireless communication unit (often referred to as wireless subscriber communication unit) to the communication infrastructure via a wireless serving base station and downlink transmissions, i.e. transmissions from the communication infrastructure to the mobile wireless communication unit via a serving base station. In TDD, the carrier frequency is subdivided in the time domain into a series of timeslots. The single carrier frequency is assigned to uplink transmissions during some timeslots and to downlink transmissions during other timeslots. In FDD systems, a pair of separated carrier frequencies is used for respective uplink and downlink transmissions. An example of communication systems using these principles is the Universal Mobile Telecommunication System (UMTS). An example of a communication system using broadcast on an unpaired carrier frequency and unicast transmissions on a paired carrier frequency can be found in WO 2007/113319. A further description of CDMA, and specifically of the Wideband CDMA (WCDMA) mode of UMTS, can be found in ‘WCDMA for UMTS’, Harri Holma (editor), Antti Toskala (Editor), Wiley & Sons, 2001, ISBN 0471486876.

In a conventional cellular system, cells in close proximity to each other are allocated non-overlapping transmission resources. For example, in a CDMA network, cells within close proximity to each other are allocated distinct spreading codes (to be used in both the uplink direction and the downlink direction). This may be achieved by, for example, by employing the same spreading codes at each cell, but a different cell specific scrambling code. The combination of these leads to effectively distinct spreading codes at each cell.

In order to provide enhanced communication services, the 3rd generation cellular communication systems are designed to support a variety of different and enhanced services. One such enhanced service is multimedia services. The demand for multimedia services that can be received via mobile phones and other handheld devices is set to grow rapidly over the next few years. Multimedia services, due to the nature of the data content that is to be communicated, require a high bandwidth.

Typically, a wireless subscriber unit is ‘connected’ to one wireless serving communication unit, i.e. one cell. Other cells in the network typically generate interfering signals to the wireless subscriber unit of interest. Due to the presence of these interfering signals a degradation of the maximum achievable data rate, which can be maintained to the wireless subscriber unit, is typical.

The typical and most cost-effective approach in the provision of multimedia services is to ‘broadcast’ the multimedia signals, as opposed to sending the multimedia signals in an uni-cast (i.e. point-to-point) manner. Typically, tens of channels carrying say, news, movies, sports, etc. may be broadcast simultaneously over a communication network.

As radio spectrum is at a premium, spectrally efficient transmission techniques are required in order to provide users with as many broadcast services as possible, thereby providing mobile phone users (subscribers) with the widest choice of services. It is known that broadcast services may be carried over cellular networks, in a similar manner to conventional terrestrial Television/Radio transmissions.

Technologies for delivering multimedia broadcast services over cellular systems, such as the Mobile Broadcast and Multicast Service (MBMS) for UMTS, have been developed over the past few years. In these broadcast cellular systems, the same broadcast signal is transmitted over non-overlapping physical resources on adjacent cells within a conventional cellular system. Consequently, at the wireless subscriber unit, the receiver must be able to detect the broadcast signal from the cell it is connected to. Notably, this detection needs to be made in the presence of additional, potentially interfering broadcast signals, transmitted on the non-overlapping physical resources of adjacent cells.

To improve spectral efficiency, broadcast solutions have also been developed for cellular systems in which the same broadcast signal is transmitted by multiple cells but using the same (i.e. overlapping) physical resources. In these systems, cells do not cause interference to each other and hence capacity is improved for broadcast services. Such systems are sometimes referred to as “Single Frequency Networks”, or SFN.

Broadcast solutions that are based on WCDMA MBMS technology tend to use long spreading codes and are associated with long transmission times per service or data block or even continuous transmission. This is a sub-optimal approach from a user device perspective, since the receiver needs to be in an ‘ON’ state for a large fraction of time, or even always in an ‘ON’ state. This can have detrimental impact in terms of viewing times for Mobile TV and other broadcast related services. The long or continuous transmission times per service demand that multiplexing of multiple services on the same carrier must be performed in the code domain.

In addition, in WCDMA, it is also known that the pilot signal is also code multiplexed with the data, which means that under highly dispersive channels (which is the normal operating condition in SFN broadcast solutions), the quality of the channel estimate can be relatively poor. Thus, data interferes with the pilot signal and degrades channel estimation quality.

Consequently, current techniques are suboptimal. Hence, an improved mechanism to address the problem of supporting broadcast transmissions over a cellular network would be advantageous.

### SUMMARY OF THE INVENTION

Accordingly, the invention seeks to mitigate, alleviate or eliminate one or more of the abovementioned disadvantages singly or in any combination.

According to aspects of the invention, there is provided, a cellular communication system, methods of operation, integrated circuits and communication units adapted to implement the concepts herein described. In accordance with some embodiments of the invention, a signal processor has been adapted to comprise logic for handling a Time Division Multiplexed (TDM) pilot at, say, a Node B (with regard to waveform construction for transmission). The TDM pilot is time-multiplexed with other data within a time slot. In a UE context, embodiments of the invention comprise logic for performing modified channel estimation in accordance with the adapted Node B transmission. Channel estimation is the process known in the art to provide, at a receiver, knowledge of the propagation channel through which a transmission has travelled in order to assist the receiver in correctly recovering transmitted data.

In accordance with some embodiments of the invention, a signal processor has been adapted to comprise logic for handling a shorter sub-frame (for example 2 msec), which may equally be applied in a Node B and UE implementation.

In accordance with some embodiments of the invention, a signal processor has been adapted to comprise logic for handling an efficient DRX cycle at the UE.

In accordance with some embodiments of the invention, a signal processor has been adapted to comprise logic for handling an increased transmission time interval (TTI) period for use with a shorter 2 msec sub-frame period, which may equally be applied in a Node B and UE implementation.

In accordance with some embodiments of the invention, a signal processor has been adapted to comprise logic for handling shorter control channels, e.g. broadcast channel (BCH), etc., which may equally be applied in a Node B and UE implementation.

In accordance with some embodiments of the invention, a signal processor has been adapted to comprise logic for handling SFN zones, which may equally be applied in a Node B and UE implementation. The term SFN zone refers to a portion of the radio resources on which a specified set of transmitters participate in the same SFN transmission. Different SFN zones may comprise different sets of participating transmitters. In this embodiment, a different scrambling code per 2 msec sub-frame may be required. A scrambling code may be assigned to an SFN zone in order to distinguish it from other SFN zones. Thus, the use of different scrambling codes for different time periods allows a transmitter to participate in correspondingly different SFN zones during those different times.

These and other aspects, features and advantages of the invention will be apparent from, and elucidated with reference to, the embodiment(s) described hereinafter.

### BRIEF DESCRIPTION OF THE DRAWINGS

Embodiments of the invention will be described, by way of example only, with reference to the accompanying drawings, in which

FIG. 1 illustrates a 3GPP cellular communication system adapted in accordance with some embodiments of the present invention.

FIG. 2 illustrates a wireless communication unit, such as a user equipment (UE) or a NodeB, adapted in accordance with some embodiments of the invention.

FIG. 3 illustrates a radio framing/timing structure in accordance with some embodiments of the invention.

FIG. 4 illustrates a transmission time interval (TTI) principle in accordance with some embodiments of the invention.

FIG. 5 illustrates slot formats in accordance with some embodiments of the invention.

FIG. 6 illustrates a pilot sequence in accordance with some embodiments of the invention.

FIG. 7 illustrates a typical computing system that may be employed to implement signal processing functionality in embodiments of the invention.

### DETAILED DESCRIPTION OF EMBODIMENTS OF THE INVENTION

The following description focuses on embodiments of the invention applicable to a UMTS (Universal Mobile Telecommunication System) cellular communication system and in particular to a UMTS Terrestrial Radio Access Network (UTRAN) operating in any unpaired spectrum within a 3^{rd} generation partnership project (3GPP) system. However, it will be appreciated that the invention is not limited to this particular cellular communication system, but may be applied to any unpaired spectrum broadcast-supporting cellular communication systems.

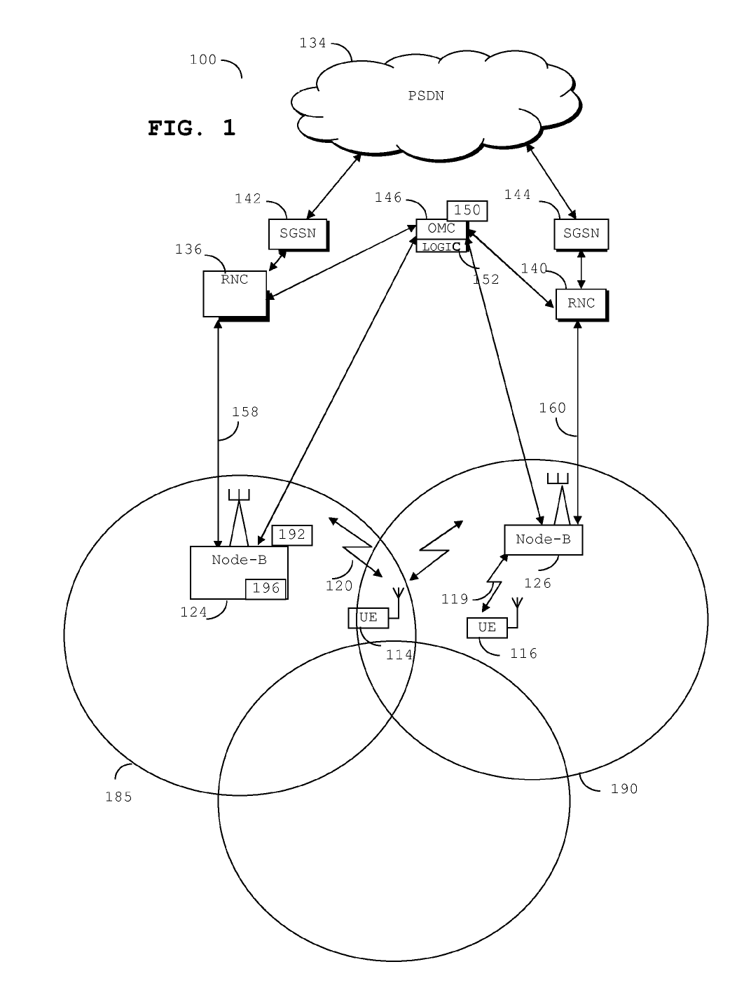

Referring now to FIG. 1, a cellular-based communication system 100 is shown in outline, in accordance with one embodiment of the present invention. In this embodiment, the cellular-based communication system 100 is compliant with, and contains network elements capable of operating over, a universal mobile telecommunication system (UMTS) air-interface. In particular, the embodiment relates to the Third Generation Partnership Project (3GPP) specification for wide-band code-division multiple access (WCDMA), time-division code-division multiple access (TD-CDMA) and time-division synchronous code-division multiple access (TD-SCDMA) standard relating to the UTRAN radio interface (described in the 3GPP TS 25.xxx series of specifications).

In particular, the 3GPP system is adapted to support both broadcast and uni-cast UTRA communication from one or more cells.

A plurality of wireless subscriber communication units/terminals (or user equipment (UE) in UMTS nomenclature) 114, 116 communicate over radio links 119, 120 with a plurality of base transceiver stations, referred to under UMTS terminology as Node-Bs, 124, 126. The system comprises many other UEs and Node-Bs, which for clarity purposes are not shown.

The wireless communication system, sometimes referred to as a Network Operator's Network Domain, is connected to an external network 134, for example the Internet. The Network Operator's Network Domain includes:

(i) A core network, namely at least one Gateway General Packet Radio System (GPRS) Support Node (GGSN) (not shown) and at least one Serving GPRS Support Nodes (SGSN) 142, 144; and

(ii) An access network, namely:
(i) A UMTS Radio network controller (RNC) 136, 140; and
(ii) A UMTS Node-B 124, 126.

The GGSN (not shown) or SGSN 142, 144 is responsible for UMTS interfacing with a Public network, for example a Public Switched Data Network (PSDN) (such as the Internet) 134 or a Public Switched Telephone Network (PSTN). The SGSN 142, 144 performs a routing and tunnelling function for traffic, whilst a GGSN links to external packet networks.

The Node-Bs 124, 126 are connected to external networks, through Radio Network Controller stations (RNC), including the RNCs 136, 140 and mobile switching centres (MSCs), such as SGSN 144. A cellular communication system will typically have a large number of such infrastructure elements where, for clarity purposes, only a limited number are shown in FIG. 1.

Each Node-B 124, 126 contains one or more transceiver units and communicates with the rest of the cell-based system infrastructure via an I_{ub} interface, as defined in the UMTS specification.

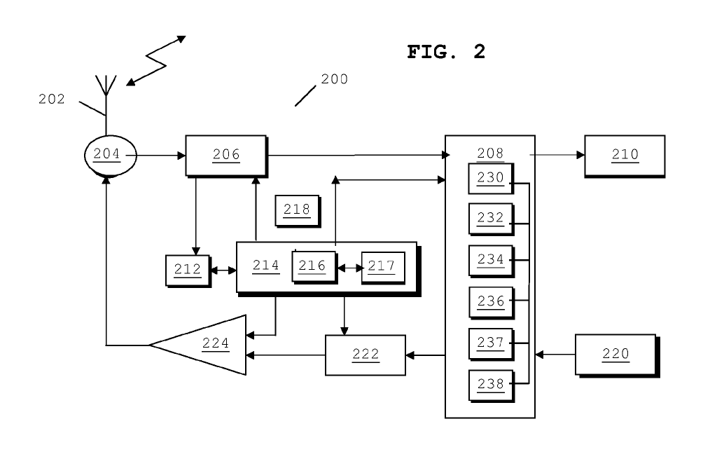

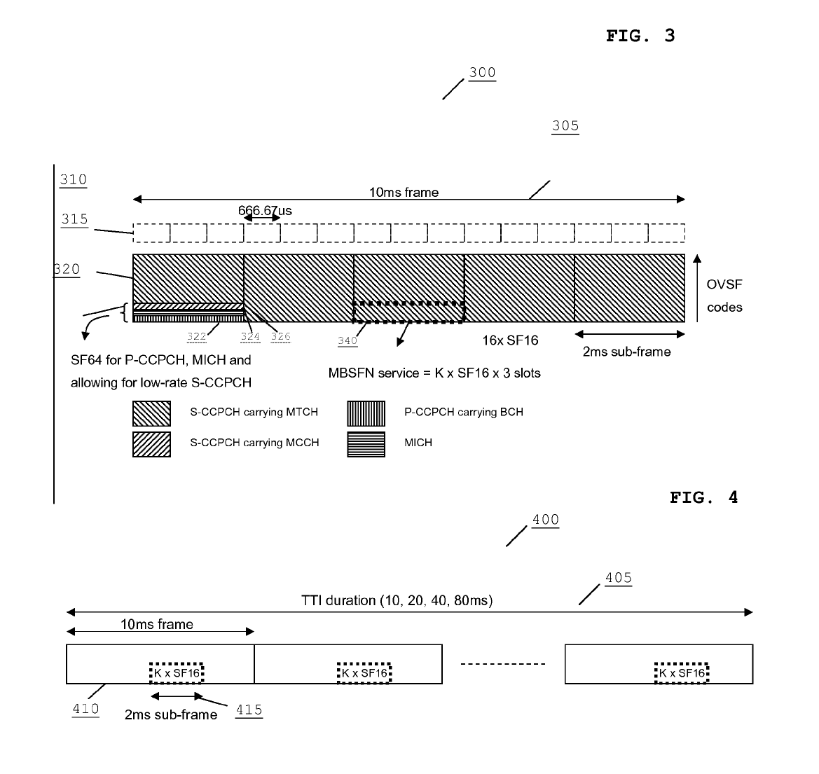

In accordance with embodiments of the invention, a first wireless serving communication unit (e.g. Node-B 124) has been adapted to comprise logic modules as detailed in FIG. 2 and described with respect to FIGS. 3-6.

In accordance with embodiments of the invention, a subscriber communication unit, such as a UE, has been adapted to comprise logic modules as detailed in FIG. 2 and further described with respect to FIGS. 3-6.

Each RNC 136, 140 may control one or more Node-Bs 124, 126. Each SGSN 142, 144 provides a gateway to the external network 134. The Operations and Management Centre (OMC) 146 is operably connected to RNCs 136, 140 and Node-Bs 124, 126. The OMC 146 comprises processing functions (not shown) and logic functionality 152 in order to administer and manage sections of the cellular communication system 100, as is understood by those skilled in the art.

Management logic 146 communicates with one or more RNCs 136, 140, which in turn provide the signalling 158, 160 to the Node-Bs and to the UEs regarding radio bearer setup, i.e. those physical communication resources that are to be used for broadcast and uni-cast transmissions.

The management logic 146 has been adapted to comprise, or be operably coupled to, broadcast mode logic 150. The broadcast mode logic 150 comprises or is operably coupled to signalling logic for signalling to the plurality of wireless subscriber communication units that part or all of the transmission resource in the cellular communication system 100 is to be configured or re-configured for broadcast mode of operation. The broadcast mode of operation is arranged to be in addition to, or as an alternative to, uni-cast transmissions.

In one embodiment of the present invention, a wireless serving communication unit, such as a Node-B, comprises a transmitter that is operably coupled to a processor 196. Embodiments of the invention utilize the processor 196 to configure or re-configure transmissions from the Node-B 124 in a broadcast mode.

The processor 196 supports downlink broadcast transmissions in addition to, or as an alternative to, uni-cast transmissions in either or both of the downlink and uplink channels of the communication system.

In one embodiment, the broadcast mode logic 150 may schedule special broadcast timeslots in addition to uni-cast transmissions.

The broadcast mode logic 150 is configured to manage the physical resources that are signaled to the RNCs and the Node Bs. In this manner, the broadcast mode logic 150 allocates resources for broadcast, sets transit powers and allocates cell IDs for resources that are to carry broadcast transmissions.

When considering the design of cellular broadcast systems, it is beneficial to consider also the degree of harmonisation that may be achieved between broadcast and unicast transmission modes. Broadcast and unicast transmission modes have different optimisation criteria, yet it is beneficial if both are able to utilise a similar underlying framework for the radio communication.

The inventors of the present invention have recognised that unicast technology in WCDMA, called high speed downlink packet access (HSDPA), has a short code component and utilises short transmission time periods (using 2 ms sub-frames) for unicast data. More information on HSDPA can be found in the 3GPP technical standard: TS25.211. These transmissions, utilising short code components and short transmission time periods, may also be mixed (using code multiplexing) with a long code component and long transmission times (or continuous transmission) for control, pilot and also for other user data. However, the use of short transmission time intervals for broadcast services is sub-optimal due to the fact that longer transmission time intervals provide robustness to temporal variations in the radio channel.

In accordance with one embodiment of the present invention, it is proposed that the short code component and short transmission times used for unicast data in HSDPA are adapted and additionally re-employed for broadcast purposes. The benefits of this approach are several fold. For example, a high degree of technology reuse is possible in the UE handset and NodeB, since similar technology (hardware, firmware and/or software) can be used for both unicast and broadcast.

In addition, in one embodiment of the invention, a long transmission time interval may be constructed using a plurality of discontinuous shorter 2 ms sub-frames. To receive the broadcast transmission the broadcast receiver is then only turned ‘ON’ for a fraction of time, thus saving battery power. This may provide more efficient power saving operation in a Discontinuous Reception (DRX) mode. Furthermore, Broadcast services may be time-multiplexed onto the same carrier, rather than code multiplexed. This ability to time-multiplex broadcast services allows for different groups of transmitters to participate in a particular single frequency network (SFN) broadcast service transmission at different times, thereby enabling a subsequent variation in the coverage area provided for each signal frequency network (SFN) service. An SFN service area is generally referred to as an “SFN zone”. An SFN broadcast transmission is one in which participating base stations transmit the same data content and same signal waveform at the same time. In CDMA SFN systems, this requires that each NodeB uses the same scrambling sequence for the active time duration of the SFN service.

In addition, the inventors have also recognised that the long code component and long transmission times of control and pilot elements in HSDPA are less suitable for broadcast systems. By replacing these control and pilot elements with a short code component and short transmission times that are consistent with the unicast communications, one or more of the following benefits may be achieved:

(i) Signalling channels (e.g. system information on the Broadcast CHannel (BCH)), which conventionally use long codes and long transmission times, are shortened and exhibit periods where no transmission is made. This means that: the receiver need only be turned ‘ON’ for a fraction of time when receiving signalling channels, thus saving battery power. In addition, other channels (such as used for broadcast services) may be transmitted when the signalling channels are not transmitted.

(ii) The pilot, called the Primary Common Pilot Channel (P-CPICH) is a long code in HSDPA and is code-multiplexed with data and other signalling. The inventors have recognised that by replacing this long P-CPICH pilot code with a short pilot,. which is time multiplexed with the data (rather than being code multiplexed), an improvement in channel estimation quality may be achieved and hence an improvement in overall system performance and sector throughput. Again the receiver is turned ‘ON’ for a fraction of time, thus saving battery power.

Referring now to FIG. 2, a block diagram of a wireless communication unit 200 is shown, adapted in accordance with some embodiments of the invention. In practice, purely for the purposes of explaining embodiments of the invention, the wireless communication unit is described in terms of either a NodeB implementation or a user equipment (UE) implementation, with the functional elements being similar. The wireless communication unit 200 contains an antenna 202 coupled to antenna switch or duplexer 204 that provides isolation between receive and transmit chains within the wireless communication unit 200.

The receiver chain, as known in the art, includes receiver front-end circuitry 206 (effectively providing reception, filtering and intermediate or base-band frequency conversion). The front-end circuitry 206 is serially coupled to a signal processing function 208. An output from the signal processing function 208 is provided to a suitable output device 210. A controller 214 maintains overall subscriber unit control. The controller 214 is also coupled to the receiver front-end circuitry 206 and the signal processing function 208 (generally realised by a digital signal processor (DSP)). The controller is also coupled to a memory device 216 that selectively stores operating regimes, such as decoding/encoding functions, synchronisation patterns, code sequences, and the like.

As regards the transmit chain, this essentially includes an input device 220, such as a keypad, coupled in series through transmitter/modulation circuitry 222 and a power amplifier 224 to the antenna 202. The transmitter/ modulation circuitry 222 and the power amplifier 224 are operationally responsive to the controller 214.

The signal processor module 208 in the transmit chain may be implemented as distinct from the processor in the receive chain. Alternatively, a single signal processor module 208 may be used to implement processing of both transmit and receive signals, as shown in FIG. 2. Clearly, the various components within the wireless communication unit 200 can be realized in discrete or integrated component form, with an ultimate structure, therefore, being an application-specific or design selection.

In accordance with some embodiments of the invention, the signal processor module 208 has been adapted to comprise logic for handling of the TDM pilot 230 at the Node B (with regard to waveform construction for transmission). In a UE context, embodiments of the invention comprise logic 230 for performing modified channel estimation in accordance with the adapted Node B transmission comprising a TDM pilot. Channel estimation is the process known in the art to provide, at a receiver, knowledge of the propagation channel through which a transmission has travelled in order to assist the receiver in correctly recovering transmitted data.

In accordance with some embodiments of the invention, the signal processor module 208 has been adapted to comprise logic for handling of the TDM pilot 230 for processing a shorter sub-frame (for example 2 msec) 232, which may equally be applied in a Node B and UE implementation.

In accordance with some embodiments of the invention, the signal processor module 208 has been adapted to comprise logic for handling an efficient DRX cycle 234 at the UE.

In accordance with some embodiments of the invention, the signal processor module 208 has been adapted to comprise logic for handling an increased TTI period for shorter 2 msec frame period 236, which may equally be applied in a Node B and UE implementation.

In accordance with some embodiments of the invention, the signal processor module 208 has been adapted to comprise logic for handling shorter control channels 237, e.g. BCH, etc., which may equally be applied in a Node B and UE implementation.

In accordance with some embodiments of the invention, the signal processor module 208 has been adapted to comprise logic for handling SFN zones 238, which may equally be applied in a Node B and UE implementation. In this embodiment, a different scrambling code per 2 msec sub-frame may be required.

The operation and function of these adapted logic modules are described in the operational description below.

Advantageously, use of a short TDM pilot enables improved channel estimation performance in broadcast deployments and improved DRX efficiency (related to the above aspect). Reuse of HSDPA short codes, short transmission times and discontinuous transmission enable the reuse of unicast transceiver technology in a broadcast network, whilst simultaneously delivering the above mentioned advantages. Embodiments of the invention propose a system that may be suitable for implementation in a multicast/broadcast single frequency network (MBSFN) transmission in unpaired frequency bands.

Embodiments of the invention aim to achieve maximal reuse of WCDMA principles, whilst accommodating the aforementioned concepts that aim to reduce complexity and cost for broadcast systems, whilst simultaneously improving performance.

The current MBSFN systems support only four primary physical channel types:

(i) Primary Common Control Physical Channel (P-CCPCH) used for system information (BCH);

(ii) Secondary Common Control Physical Channel (S-CCPCH) used for Multimedia Broadcast and Multicast Services (MBMS) control information and also MBMS user data;

(iii) MBMS notification indication channel (MICH) used for service notification purposes; and

(iv) Synchronisation Channel (SCH) used for cell search and frame synchronisation.

Frequency division duplex (FDD) MBSFN supports also the P-CPICH, which serves as the pilot for data demodulation purposes. The system employed in embodiments of the invention is based on at least one of the following:

(i) Use of receiver structures with dual receive antennas and chip-level equalisation, commonly known as “type-3” FDD HSDPA receiver principles

(ii) Adoption of the 2 ms sub-frame structure as used for FDD HSDPA;

(iii) Use of SF16 for S-SCCPCH where possible (aligned with FDD HSDPA), noting that in FDD MBMS this is SF256, SF128, SF64,SF32, SF16, SF8, SF4, where transmission is continuous;

(iv) Use of SF64 for P-CCPCH and MICH;

(v) Use of FDD chip-level scrambling sequences; and

(vi) Use of a time division multiplexed (TDM) pilot structure for both QPSK and 16-QAM transmissions.

In CDMA systems, the data rate of a physical channel is governed by (amongst others) the spreading factor of the channel. Longer spreading factors result in lower transmission rates, whilst shorter spreading factors result in higher transmission rates. To supply a given data rate, a channel may use a shorter spreading factor than is necessary, and to transmit the channel for only a fraction of the time. Through such use of lower spreading factors, the duration of the common control channels on a carrier supporting broadcast transmissions may be shortened to 2 msec per radio frame, hence providing time periods where other channels may be transmitted and thereby accommodating a TDM component for MBSFN services, which may be used to:

(i) implement more efficient DRX whereby a UE receiver need be turned ON for only a fraction of time to receive the control or broadcast data, thereby saving battery power;

(ii) lower the UE complexity; and

(iii) provide multiple time-multiplexed SFN zones if desired to support the delivery of broadcast content over varying coverage/distribution areas.

For SFN transmission, wherein multiple cells transmit the same waveform, a corresponding plurality of copies of the transmitted signal are present at the UE receiver but each with differing time delays and amplitudes and phases due to their passage through the respective radio propagation channels and reflection/refraction due to intervening physical objects. These are observed by the UE receiver as a single transmission source received over a single complex radio propagation channel environment comprising the multiple delays. The extent in time between the first and last arrival of these signal paths is commonly referred to as the delay spread of the channel. For SFN broadcast deployments, the delay spread can therefore be significantly larger than observed for unicast deployments. The use of a TDM pilot for broadcast transmissions is able to significantly improve link performance compared to the code-multiplexed P-CPICH when used in such SFN channels with extended delay spread and many more delay paths than are usually present in unicast channel environments. This is because in the code-multiplexed pilot case, even though the pilot and other signals are constructed at the transmitter such as to be orthogonal to each other (in the code domain), this property is often destroyed by the time the signal arrives at the receiver due to the long delay spread in the complex radio channel. This loss of orthogonality causes interference to the pilot from other code-multiplexed signals and impairs the ability of the receiver to accurately estimate the radio channel and to recover the transmitted data.

Conversely, channel estimation using a TDM pilot can be arranged to avoid interference effects generated by the SFN radio propagation channel. However, the pilot sequence used for the TDM pilot must exhibit the necessary properties that make it suitable for channel estimation.

Referring now to FIG. 3, a framing format 300 as adapted according to embodiments of the invention, is illustrated. Embodiments of the invention propose that the same FDD MBMS 10 msec frame 305 and slot durations 315 are retained. FIG. 3 outlines the frame structure 300 using 2 msec 320 HSDPA-like sub-frame units for the three main physical channel types (noting that FIG. 3 excludes SCH). Thus, in FIG. 3, 2 msec subframes 320 (each comprising 3 equal-length time slots 315) are used for S-CCPCH purposes, carrying an MBSFN service 340 via a multicast traffic channel (MTCH) 322. The MBSFN service 340 is actively transmitted during only 3 slots of the 10 ms radio frame. The 2 msec subframes 320 use orthogonal variable spreading factor (OVSF) codes. As illustrated, in accordance with embodiments of the invention, and using a spreading factor SF64, one or more of the 2 msec subframes 320 may also be employed for: S-CCPCH purposes carrying a multicast control channel (MCCH) 324, a P-CCPCH carrying a BCH 322 and MICH 326. Also illustrated in FIG. 3 is a use of three slots, each employing K codes at spreading factor 16 to support an MBSFN service 340.

By including such a time-domain-multiplexing component to the radio framing structure for the various data and control channels, this approach may serve either or both of the following purposes:

(i) Efficient DRX (reduced receiver on time) and, hence, lower power consumption, thereby extending battery life.

(ii) Reduced UE complexity/cost due to the replacement of TTI DRX with intra-frame DRX.

A TTI DRX is where a whole TTI is received, then “N” subsequent TTIs are not received. The transmitter operates in the same manner. This means that the volume of data contained within a TTI {i.e. the active one} needs to be (N+1) times larger than the volume per TTI required to achieve the mean desired bit rate for the service.

DRX schemes that operate on a sub-TTI level (e.g. slot or sub-frame based), can implement the same 1:N (on:off) ratio. However, because every TTI is active, the volume of data shipped per TTI remains equal to only 1× the volume per TTI required to achieve the mean desired bit rate for the service. Thus, the complexity of the receiver processing may be reduced as the data volumes it needs to handle per TTI are reduced.

Referring now to FIG. 4, one example of a TTI principle 400, as adapted according to embodiments of the invention, is illustrated. Embodiments of the invention construct long TTI durations (10 msec., 20 msec., 40 msec. and 80 msec.) 405 of the transport channels, the long TTIs consisting of ‘1’, ‘2’, ‘4’ or ‘8’ disjoint sub-frames 415 per frame 410 as shown in FIG. 4. Through the use of only one 2 msec sub-frame 415 per radio frame 410 to transmit an MBSFN service, the receiver needs to be active for only one fifth of the time compared to the case of continuous transmission of an MBSFN service. Thus the power saving and battery life improvements achieved through DRX are clearly evident in FIG. 4. Note also that this form of intra-frame DRX does not increase the transport block set size (i.e. the volume of data carried in one TTI). Therefore, the transport channel processing complexity is not increased and may be lower than in the known WCDMA MBMS techniques.

Embodiments of the invention, as shown in FIG. 4, illustrate 2 msec sub-frames 415 in each radio frame 410 for the duration of the TTI, e.g. 80 msec. In HSPDA, TTI durations spanning multiple radio frames are not supported, since HSDPA employs only one short TTI duration of 2 msec and uses scheduling and retransmissions to overcome variations in the channel. In broadcast systems, unicast scheduling does not exist, so to overcome channel variations embodiments of the invention may employ a large TTI constructed out of a plurality of discontinuous 2 ms sub-frames as shown in FIG. 4). Longer TTIs allow for longer interleaving depths, which when combined with forward error correction provide for increased robustness against temporal channel variations.

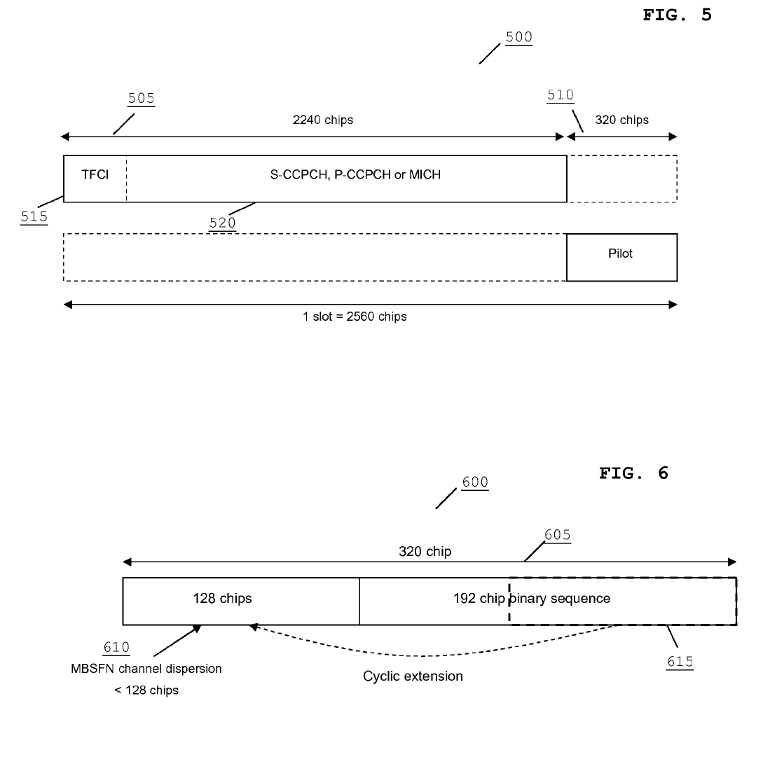

Referring now to FIG. 5, slot formats 500 exhibiting particular timing structures, as adapted according to embodiments of the invention, are illustrated. Embodiments of the invention propose that the slot/timing formats 500 are based around the general WCDMA principle for S-CCPCH with transport format combination index (TFCI) 515 (if present) at the beginning and a region of no data transmission 510 at the end. This field 510 is used for transmission of a pilot sequence thereby providing time-division multiplexing of the data and pilot fields.

In accordance with embodiments of the invention, SF1, SF16 and SF64 may be supported during the data field 520, with SF64 for P-CCPCH, S-CCPCH carrying MCCH and MICH and with SF16 and SF1 for S-CCPCH carrying MTCH. The SF1 option permits a lower peak to average power ratio (PAPR) at the Node B transmitter and can allow for increased coverage for MBMS services, hence, requiring fewer base stations to cover a particular geographical area with a particular service rate. These spreading factor options are designed to accommodate the necessary range of MBMS service rates (e.g. from around 32 kbps to 512 kbps) and also to handle low rate common signalling at typical forward error correction (FEC) code rates. It is noteworthy that lower rates for MBMS services may also be supported via higher layer service scheduling, as is currently the case for MBSFN.

Different scrambling sequences may be used per S-CCPCH 2 msec sub-frame to enable support for multiple time-multiplexed SFN zones.

Different data modulation techniques may be applied, including those commonly known in the art, such as QPSK and 16-QAM. Modulation schemes for P-CCPCH, S-CCPCH and MICH may not be changed from the current specifications.

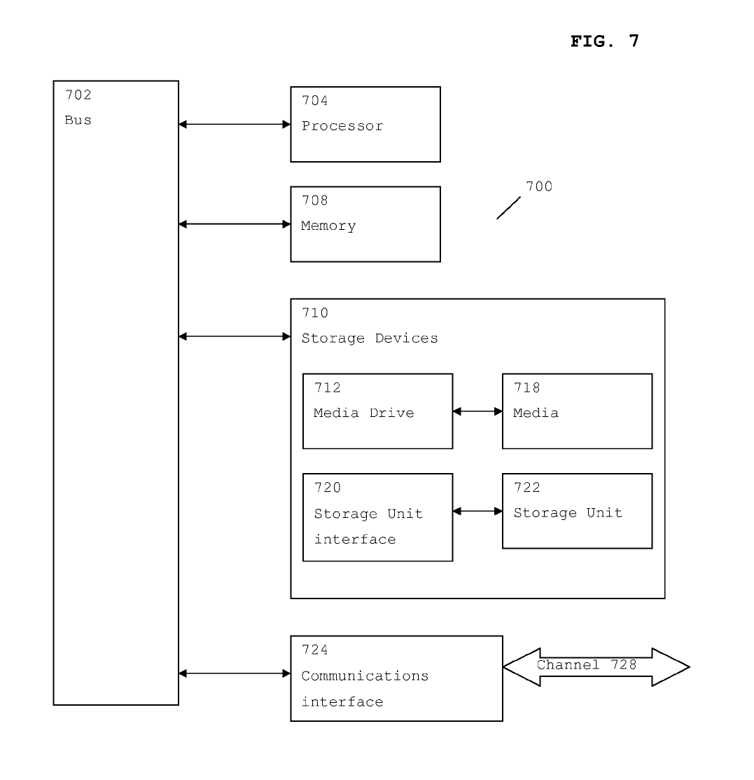

Referring now to FIG. 6, an example of a pilot sequence 600, as adapted according to embodiments of the invention, is illustrated. Embodiments of the invention propose that, for broadcast communications, the WCDMA CDM pilot (P-CPICH) is replaced by a time division multiplexed (TDM) pilot. The TDM pilot is a relatively short sequence and is arranged to exhibit the necessary properties to facilitate good channel estimation. These properties may include desirable correlation properties. Sequences with low auto-correlation (except at zero-lag) allow for accurate channel estimation and low noise enhancement properties when using for example zero forcing channel estimation). A set of sequences with good cross correlation properties (between pilot sequences in use in other cells) is also desirable.

It may also be beneficial in one embodiment of the invention if the sequence is cyclic, as this can allow for more efficient implementation of the channel estimation process in the receiver. This is due to the fact that the use of cyclic sequences is compatible with the use of Discrete Fourier Transform (DFT) frequency-domain processing methods. Furthermore, even in a dispersive channel the received TDM pilot contains a signal region in time that is not interfered with by data. A time region occurring at the start of the received TDM pilot field and of length equal to the channel dispersion time does suffer from interference from the data region of the slot. However, the remainder of the received TDM pilot field is interference free, hence this interference-free region allows for high quality estimation of the radio channel. This represents an improvement compared to the WCDMA code-division-multiplexed (CDM) pilot that, as aforementioned, always suffers from interference from data in SFN radio channels due to loss of code-domain orthogonality between the pilot and data signals.

Common pilot sequences used for MBSFN in time division duplex (TDD) systems exhibit these good properties as described for channel estimation and may be used as suitable sequences for a TDM pilot to enable channel estimation in a modified WCDMA MBMS system.

The pilot construction is given in FIG. 6. Points to note may include:

(i) The 128 chip cyclic prefix 610 may be matched to the maximum expected MBSFN channel dispersion. Thus, channel estimation may be based on the received signal corresponding to the subsequent 192 chip binary sequence, and which remains free from interference from the data

(ii) The short 192 chip binary sequence 615 may be designed to exhibit good channel estimation properties.

The short sequence length of 192 chips may also enable a very efficient channel estimator to be used that exhibits low complexity and low cost. If the TDM pilot sequence transmitted is linked to the cell ID in use, then the TDM pilot sequence may also be used to assist with determination of the cell ID (a function typically carried out using the synchronisation channel—SCH). The channel coding may be restricted to use of only a single decoding type (e.g. turbo coding), in order to reduce the complexity of the receiver by removing the need for other types of decoder (such as a Viterbi decoder). This helps to reduce UE complexity and cost for the MBSFN receiver.

It is envisaged in one embodiment of the invention that other complementary techniques that exist in current standards could be readily used in conjunction with the proposed techniques, for example existing techniques of channel coding, spreading and other procedures from the existing 3GPP FDD or TDD specifications.

One intention of the aforementioned techniques is to minimise the impact of the physical layer features of the invention with respect to the higher layers. The principles of MBSFN mobility and user plane and control plane architectures may correspond to those in existing FDD or TDD MBSFN systems. Modifications could be envisaged that achieve one or more of the above benefits and involve the radio resource control (RRC) layer and NodeB Application Protocol (NBAP) configuration in order to accommodate some parameters of specific relevance to the physical layer. Thus, advantageously, no modification to the core network and associated services/applications are required to achieve the aims of the aforementioned embodiments.

At the physical layer, the aforementioned concepts are intended to make use of current HSDPA type-3 receivers with associated modifications to support efficient broadcast.

Referring now to FIG. 7, there is illustrated a typical computing system 700 that may be employed to implement signal processing functionality in embodiments of the invention. Computing systems of this type may be used in access points and wireless communication units. Those skilled in the relevant art will also recognize how to implement the invention using other computer systems or architectures. Computing system 700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special-purpose processing engine such as, for example, a microprocessor, microcontroller or other control logic. In this example, processor 704 is connected to a bus 702 or other communications medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 718 may include, for example, a hard disk, floppy disk, magnetic tape, optical disk, CD or DVD, or other fixed or removable medium that is read by and written to by media drive 712. As these examples illustrate, the storage media 718 may include a computer-readable storage medium having particular computer software or data stored therein.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a universal serial bus (USB) port), a PCMCIA slot and card, etc. Software and data transferred via communications interface 724 are in the form of signals which can be electronic, electromagnetic, and optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ computer-readable medium' and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as ‘computer program code’ (which may be grouped in the form of computer programs or other groupings), when executed, enable the computing system 700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 722, drive 712 or communications interface 724. The control logic (in this example, software instructions or computer program code), when executed by the processor 704, causes the processor 704 to perform the functions of the invention as described herein.

It will be appreciated that, for clarity purposes, the above description has described embodiments of the invention with reference to different functional units and processors. However, it will be apparent that any suitable distribution of functionality between different functional units or processors, for example with respect to the broadcast mode logic or management logic, may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second” etc. do not preclude a plurality.

1. A method for supporting broadcast transmissions and unicast communications in a wireless communication system, the method comprising:
supporting unicast communication in a first mode of operation wherein at least one unicast data transmission unit is encoded and communicated within a time-continuous sub-frame of a first length and a first number of timeslots; and
supporting broadcast transmission in a second mode of operation, wherein at least one broadcast data transmission unit is encoded and communicated over a time period that comprises a discontinuous plurality of the time-continuous sub-frames of the first length.

2. The method of claim 1 wherein supporting broadcast transmission in a second mode of operation comprises concatenating the discontinuous plurality of the time-continuous sub-frames to generate an extended transmission time interval for the broadcast transmission.

3. The method of claim 1 wherein encoding the broadcast data transmission unit comprises mapping the at least one broadcast data transmission unit to at least one simultaneously transmitted code division multiple access (CDMA) code(s) of a first spreading factor.

4. The method of claim 3 wherein encoding the at least one unicast data transmission unit comprises mapping the at least one unicast data transmission unit to at least one simultaneously transmitted CDMA code(s) of the first spreading factor.

5. The method of claim 1 wherein the time-continuous sub-frame comprises a 2 ms sub-frame.

6. The method of claim 1 wherein the unicast communication comprises high speed downlink packet access (HSDPA).

7. The method of claim 6 further comprising, at a base station, inserting a short time domain pilot code into at least one timeslot of the discontinuous plurality of time-continuous sub-frames for broadcast transmission.

8. The method of claim 7 further comprising time multiplexing the short time domain pilot code with data in the broadcast transmission.

9. The method of claim 1 wherein at least one timeslot of the discontinuous plurality of time-continuous sub-frames comprises a short time domain pilot code, the method further comprising, at a user equipment, utilizing the short time domain pilot code to perform channel estimation.

10. The method of claim 1 further comprising, at a user equipment, employing time-discontinuous receiver operation within the discontinuous plurality of the time-continuous sub-frames when receiving the broadcast transmission.

11. The method of claim 1 further comprising performing the broadcast transmission using a Single Frequency Network (SFN) mode of transmission from multiple base stations.

12. The method of claim 1 wherein the broadcast transmission occurs on an unpaired carrier dedicated to Multicast Broadcast Single Frequency Network (MBSFN) transmission.

13. The method of claim 1 further comprising, at a user equipment, using a type-3 receiver both to receive the unicast transmission in the first mode of operation and to receive the broadcast transmission in the second mode of operation.

14. The method of claim 1 further comprising time-multiplexing a broadcast data service with another broadcast data service.

15. The method of claim 1 further comprising time-multiplexing broadcast common control channels with other data.

16. The method of claim 15 wherein time-multiplexing further comprises encoding at least one broadcast common control channel.

17. The method of claim 16 wherein the at least one broadcast common control channel comprises at least one selected from the group consisting of: broadcast channel (BCH), MBMS control channel (MCCH), and MBMS notification indication channel (MICH).

18. The method of claim 16 further comprising mapping, using a reduced spreading factor, the at least one encoded broadcast common control channel to a number less than a total of time-continuous sub-frames of a radio frame such that broadcast common control channel transmissions are time discontinuous.

19. The method of claim 1 wherein the wireless communication system comprises third generation partnership project (3GPP) wideband code division multiple access (CDMA) technology.

20. A non-transitory computer program product having executable program code stored therein for supporting broadcast transmissions and unicast communications in a wireless communication system, the executable program code, when executed at an apparatus in a wireless communication system, operable for:
supporting unicast communication in a first mode of operation wherein at least one unicast data transmission unit is encoded and communicated within a time-continuous sub-frame of a first length and a first number of timeslots; and
supporting broadcast transmission in a second mode of operation, wherein at least one broadcast data transmission unit is encoded and communicated over a time period that comprises a discontinuous plurality of the time-continuous sub-frames of the first length.

21. A communication unit for supporting broadcast transmissions and unicast communications in a wireless communication system, the communication unit comprising a signal processing module comprising:
logic for supporting unicast communication in a first mode of operation wherein at least one unicast data transmission unit is encoded and communicated within a time-continuous sub-frame of a first length and a first number of timeslots; and
logic for supporting broadcast transmission in a second mode of operation, wherein at least one broadcast data transmission unit is encoded and communicated over a time period that comprises a discontinuous plurality of the time-continuous sub-frames of the first length.

22. The communication unit of claim 21, wherein the communication unit is a base station comprising logic arranged to concatenate the discontinuous plurality of the time-continuous sub-frames to generate an extended transmission time interval for the broadcast transmission.

23. The communication unit of claim 21, wherein the communication unit is a user equipment and wherein the broadcast transmission comprises a short time domain pilot code, the user equipment comprising logic for performing channel estimation utilizing the short time domain pilot code.

24. An integrated circuit for a communication unit to support broadcast transmissions and unicast communications in a wireless communication system, the integrated circuit comprising a signal processing module comprising:
logic for supporting unicast communication in a first mode of operation wherein at least one unicast data transmission unit is encoded and communicated within a time-continuous sub-frame of a first length and a first number of timeslots; and
logic for supporting broadcast transmission in a second mode of operation, wherein at least one broadcast data transmission unit is encoded and communicated over a time period that comprises a discontinuous plurality of the time-continuous sub-frames of the first length.

25. A wireless cellular communication system for supporting broadcast transmissions and unicast communications between a base station and at least one user equipment, the wireless cellular communication system comprising:
logic for supporting unicast communication in a first mode of operation wherein at least one unicast data transmission unit is encoded and communicated within a time-continuous sub-frame of a first length and a first number of timeslots; and
logic for supporting broadcast transmission in a second mode of operation, wherein at least one broadcast data transmission unit is encoded and communicated over a time period that comprises a discontinuous plurality of the time-continuous sub-frames of the first length.
